(19) United States
(12) Patent Application Publication
(10) Pub. No.: US 2025/0252921 A1
(43) Pub. Date: Aug. 7, 2025

(54) ELECTROLUMINESCENT DISPLAY APPARATUS AND DRIVING METHOD OF THE SAME

(71) Applicant: LG Display Co., Ltd., Seoul (KR)

(72) Inventors: Byung Sam MIN, Paju-si (KR); In Yeong KONG, Paju-si (KR); Seung Hwan SHIN, Paju-si (KR)

(73) Assignee: LG Display Co., Ltd., Seoul (KR)

(21) Appl. No.: 18/978,375

(22) Filed: Dec. 12, 2024

(30) Foreign Application Priority Data
Feb. 2, 2024 (KR) 10-2024-0016858

(51) Int. Cl. G09G 3/3233

(52) U.S. Cl. CPC G09G 3/3233; G09G 2300/0842; G09G 2310/08; G09G 2320/0233; G09G 2320/0626; G09G 2340/0435

(57) ABSTRACT

An electroluminescent display apparatus includes a display panel including a target pixel for sensing, a data driver configured to supply a display data voltage to the target pixel in an image writing period of one frame, supply a sensing data voltage to the target pixel in a sensing period, supply a luminance compensation data voltage to the target pixel in a sensing line compensation period, and supply a luminance recovery data voltage to the target pixel in a recovery period, and a sensing circuit configured to sense an electrical characteristic of the target pixel based on the sensing data voltage in the sensing period. The image writing period, the sensing period, the sensing line compensation period, and the recovery period may be sequentially arranged. The luminance compensation data voltage may have a voltage level higher than the display data voltage.

### CROSS-REFERENCE TO RELATED APPLICATION

This application claims the benefit of Korean Patent Application No. 10-2024-0016858, filed on Feb. 2, 2024, which is hereby incorporated by reference as if fully set forth herein.

### BACKGROUND

### Field

The present disclosure relates to an electroluminescent display apparatus and a driving method thereof.

### Discussion of the Related Art

Each of pixels of electroluminescent display apparatuses includes a light emitting device self-emitting light. Electroluminescent display apparatuses control the amount of light emitted from the light emitting device with a data voltage based on a gray level of image data to adjust luminance.

Electroluminescent display apparatuses use external compensation technology for increasing image quality. The external compensation technology senses the electrical characteristic of pixels in the middle of displaying an image and adjusts data of an input image on the basis of a sensed result, thereby compensating for an electrical characteristic deviation between pixels.

The electrical characteristic of pixels may be sensed in the middle of displaying an input image. At this time, a sensing pixel temporarily stops the emission of light during a sensing period. That is, the electrical characteristic of pixels is sensed in a non-emission state. Due to this, a luminance deviation between a sensing pixel and a non-sensing pixel may occur. Such a problem is more worsened in variable refresh rate (VRR) driving where a frame frequency varies based on an input image.

### SUMMARY

To overcome the aforementioned problem of the related art, the present disclosure may provide an electroluminescent display apparatus and a driving method thereof, which may decrease a luminance deviation occurring between a sensing pixel and a non-sensing pixel.

To achieve these objects and other advantages and in accordance with the purpose of the disclosure, as embodied and broadly described herein, an electroluminescent display apparatus includes a display panel including a target pixel for sensing, a data driver configured to supply a display data voltage to the target pixel in an image writing period of one frame, supply a sensing data voltage to the target pixel in a sensing period, supply a luminance compensation data voltage to the target pixel in a sensing line compensation period, and supply a luminance recovery data voltage to the target pixel in a recovery period, and a sensing circuit configured to sense an electrical characteristic of the target pixel based on the sensing data voltage in the sensing period, wherein the image writing period, the sensing period, the sensing line compensation period, and the recovery period are sequentially continued, the luminance compensation data voltage has a voltage level which is higher than the display data voltage, and the luminance recovery data voltage is determined within a recovery voltage range including the display data voltage and the luminance compensation data voltage.

In another aspect of the present disclosure, a driving method of an electroluminescent display apparatus, including a display panel including a target pixel for sensing, includes supplying a display data voltage to the target pixel in an image writing period of one frame, supplying a sensing data voltage to the target pixel in a sensing period, supplying a luminance compensation data voltage to the target pixel in a sensing line compensation period, and supplying a luminance recovery data voltage to the target pixel in a recovery period and sensing an electrical characteristic of the target pixel based on the sensing data voltage in the sensing period, wherein the image writing period, the sensing period, the sensing line compensation period, and the recovery period are sequentially continued, the luminance compensation data voltage has a voltage level which is higher than the display data voltage, and the luminance recovery data voltage is determined within a recovery voltage range including the display data voltage and the luminance compensation data voltage.

Additional features and aspects of the disclosure will be set forth in the description that follows and in part will become apparent from the description or may be learned by practice of the inventive concepts provided herein. Other features and aspects of the inventive concepts may be realized and attained by the structure particularly pointed out in, or derivable from, the written description, claims hereof, and the appended drawings.

It is to be understood that both the foregoing general description and the following detailed description of the present disclosure are by way of example and are intended to provide further explanation of the disclosures.

### BRIEF DESCRIPTION OF THE DRAWINGS

The accompanying drawings, which are included to provide a further understanding of the disclosure and are incorporated in and constitute a part of this application, illustrate aspects of the disclosure and together with the description serve to explain the principle of the disclosure. In the drawings:

FIG. 1 is a diagram illustrating an electroluminescent display apparatus according to an example embodiment of the present disclosure;

FIG. 2 is a diagram illustrating an example pixel array included in the electroluminescent display apparatus of FIG. 1;

FIG. 3 is a diagram illustrating one pixel included in the pixel array of FIG. 2 and a sensing circuit connected thereto according to an example embodiment of the present disclosure;

FIGS. 4 and 5 are diagrams for describing variable refresh rate (VRR) driving;

FIG. 6 is a diagram illustrating an example case where real-time (RT) sensing driving, sensing line compensation (SLC) driving, and recovery driving are performed on one sensing pixel line at a different position for each frame;

FIG. 7 is a diagram illustrating an example where a compensation gain is differentially set based on a length of an SLC period;

FIGS. 8 and 9 are diagrams illustrating display driving of a non-sensing pixel line according to an example embodiment of the present disclosure;

FIGS. 10 and 11 are diagrams illustrating a case where long-time SLC driving succeeding RT sensing driving is performed on a sensing pixel line, in a comparative example;

FIGS. 12 and 13 are diagrams illustrating RT sensing driving, SLC driving, and recovery (RECV) driving of a sensing pixel line in an example embodiment; and

FIG. 14 is a diagram illustrating a driving method of an electroluminescent display apparatus according to an example embodiment of the present disclosure.

### DETAILED DESCRIPTION

Hereinafter, the present disclosure will be described more fully with reference to the accompanying drawings, in which example embodiments of the disclosure are shown. The disclosure may, however, be embodied in many different forms and should not be construed as being limited to the example embodiments set forth herein. Rather, these example embodiments are provided so that this disclosure will be thorough and complete, and will fully convey the concept of the disclosure to those skilled in the art.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure will be thorough and complete, and will fully convey the scope of the present disclosure to those skilled in the art.

The shapes, sizes, ratios, angles, numbers and the like disclosed in the drawings for description of various embodiments of the present disclosure to describe embodiments of the present disclosure are merely examples, and the present disclosure is not limited thereto. Like reference numerals refer to like elements throughout. Throughout this specification, the same elements are denoted by the same reference numerals. As used herein, the terms “comprise,” “having,” “including,” and the like suggest that other parts can be added unless a term like “only” is used. As used herein, the singular forms “a,” “an,” and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜,” “over˜,” “under˜,” and “next˜,” one or more other parts may be disposed between the two parts unless a term like “just” or “direct” is used.

It will be understood that, although the terms “first”, “second”, etc., may be used herein to describe various elements, these elements should not be limited by these terms. These terms are only used to distinguish one element from another. For example, a first element could be termed a second element, and, similarly, a second element could be termed a first element, without departing from the scope of the present disclosure.

Like reference numerals refer to like elements throughout.

In the specification, a gate driving circuit provided on a substrate of a display panel may be implemented with a thin film transistor (TFT) having an n-type metal oxide semiconductor field effect transistor (MOSFET) structure, but is not limited thereto and may be implemented with a TFT having a p-type MOSFET structure. A TFT may be a three-electrode element which includes a gate, a source, and a drain. The source may be an electrode which supplies a carrier to a transistor. In the TFT, a carrier may start to flow from the source. The drain may be an electrode which enables the carrier to flow out from the TFT. That is, in a MOSFET, the carrier flows from the source to the drain. In the n-type TFT (NMOS), because a carrier is an electron, a source voltage may have a lower voltage than a drain voltage so that the electron flows from the source to the drain. In the n-type TFT, because the electron flows from the source to the drain, a current may flow from the drain to the source. On the other hand, in the p-type TFT (PMOS), because a carrier is a hole, a source voltage may be higher than a drain voltage so that the hole flows from the source to the drain. In the p-type TFT, because the hole flows from the source to the drain, a current may flow from the source to the drain. It should be noted that a source and a drain of a MOSFET are not fixed but switch therebetween. For example, the source and the drain of the MOSFET may switch therebetween. Therefore, in describing embodiments of the present disclosure, one of a source and a drain will be described as a first electrode, and the other of the source and the drain will be described as a second electrode.

In the following description, when the detailed description of the relevant known function or configuration is determined to unnecessarily obscure the important point of the present disclosure, the detailed description will be omitted. Hereinafter, example embodiments of the present disclosure will be described in detail with reference to the accompanying drawings.

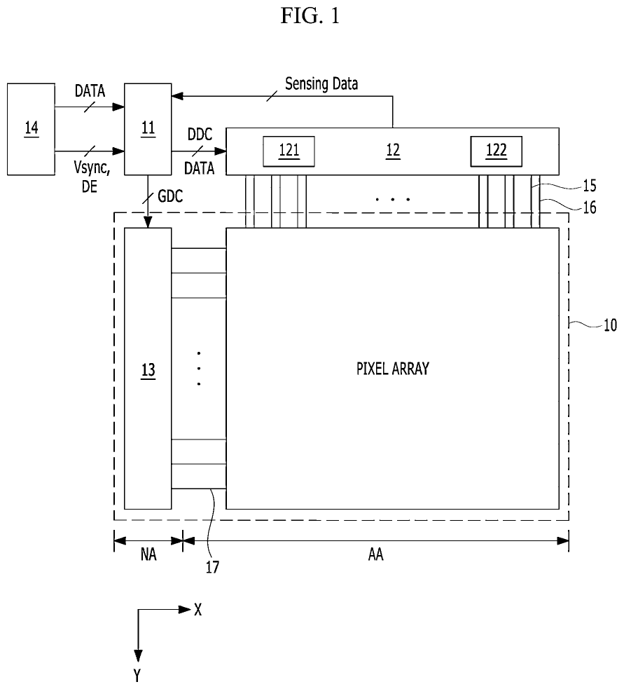

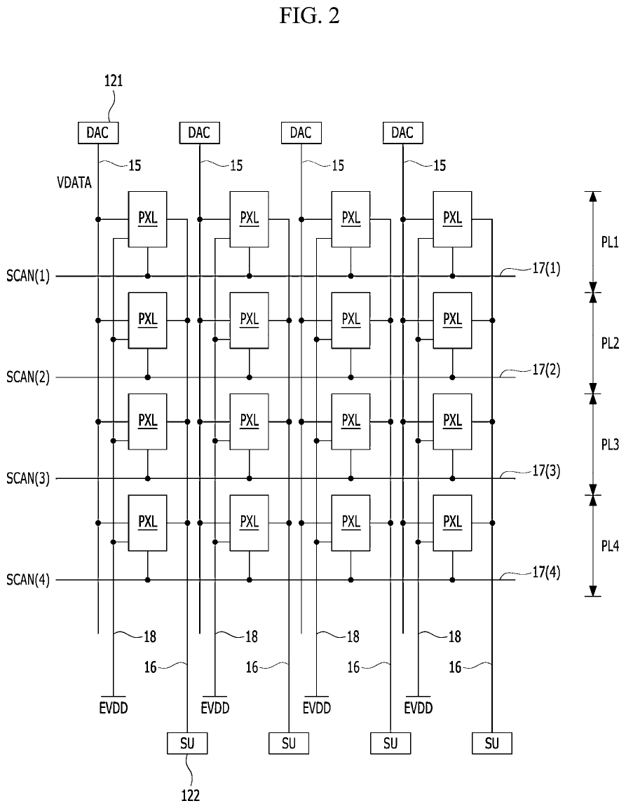

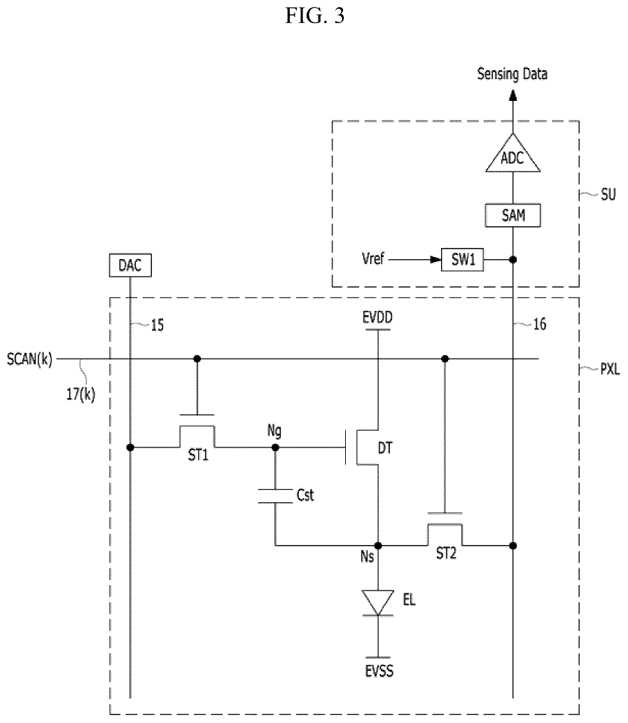

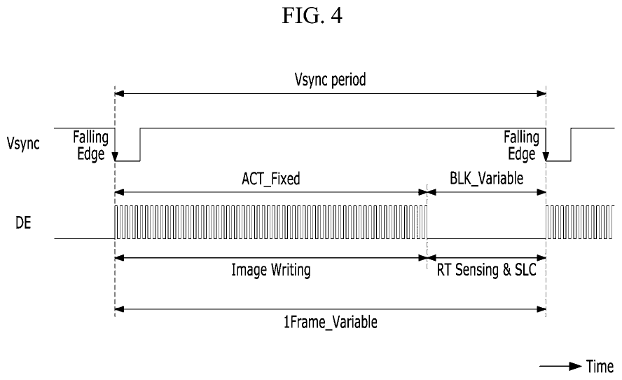

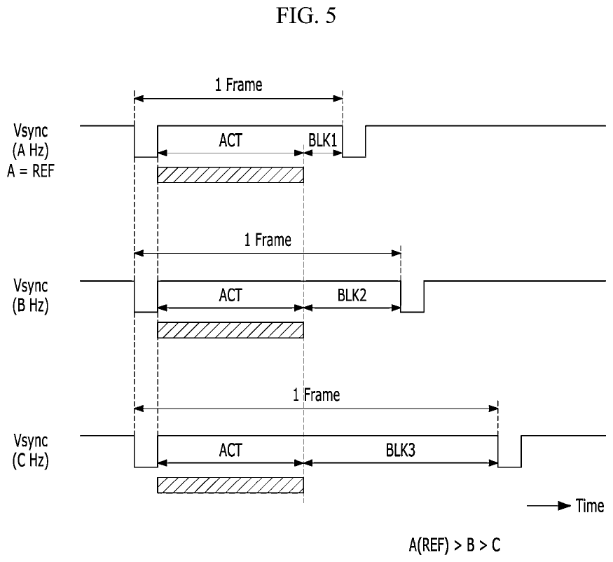

FIG. 1 is a diagram illustrating an electroluminescent display apparatus according to an example embodiment of the present disclosure. FIG. 2 is a diagram illustrating a pixel array included in the electroluminescent display apparatus of FIG. 1. FIG. 3 is a diagram illustrating one pixel included in the pixel array of FIG. 2 and a sensing circuit connected thereto. FIGS. 4 and 5 are diagrams for describing variable refresh rate (VRR) driving.

As illustrated in FIGS. 1 and 2, the electroluminescent display apparatus according to an example embodiment of the present disclosure may include a display panel 10, a timing controller 11, a data driver 12, a gate driver 13, and a sensing circuit 122.

The display panel 10 may include a plurality of data lines 15, a plurality of readout lines 16, and a plurality of gate lines 17. Also, a plurality of pixels PXL may be arranged in a plurality of intersection areas between the data lines 15, the readout lines 16, and the gate lines 17. A pixel array illustrated in FIG. 2 may include the plurality of pixels PXL arranged as a matrix type and may be provided in a display area AA of the display panel 10.

In the pixel array, pixel lines PL1 to PL4 may be implemented by pixels PXL adjacent to one another in an extension direction (i.e., an X-axis direction) of the gate line 17. Each of the pixel lines PL1 to PL4 may include a plurality of pixels PXL adjacent to one another in the X-axis direction. Pixels PXL configuring the same pixel line PL may be connected to the same gate line 17 and may be connected to different data lines 15. Pixels PXL configuring the same pixel line PL may be connected to different readout lines 16 but are not limited thereto, and a plurality of pixels PXL for implementing different colors may share one readout line 16.

In the pixel array, each pixel PXL may be connected to a data voltage supply unit (DAC) 121 through one of the data lines 15, connected to the sensing circuit 122 through one of the readout lines 16, and connected to the gate driver 13 through one of the gate lines 17. Also, each pixel PXL may be connected to a high level pixel power EVDD through a high level power line 18.

In the pixel array, the pixels PXL may include pixels which implement a first color, pixels which implement a second color, and pixels which implement a third color, and moreover, may further include pixels which implement a fourth color. The first to fourth colors may selectively be one of red, green, blue, and white.

Each pixel PXL may be implemented as in FIG. 3 but is not limited thereto.

As shown in FIG. 3, a pixel PXL arranged in a kth (where k is an integer) pixel line PLk may include a light emitting device EL, a driving transistor DT, a storage capacitor Cst, a first switch transistor ST1, and a second switch transistor ST2, and the first switch transistor ST1 and the second switch transistor ST2 may be connected to the same gate line 17(k).

The light emitting device EL may emit light with a pixel current. The light emitting device EL may include an anode electrode connected to a source node Ns, a cathode electrode connected to a low level pixel power EVSS, and an organic or inorganic compound layer disposed between the anode electrode and the cathode electrode. The organic or inorganic compound layer may include a hole injection layer (HIL), a hole transport layer (HTL), an emission layer (EML), an electron transport layer (ETL), and an electron injection layer (EIL). When a voltage applied to the anode electrode is higher than an EL operation point voltage compared to the low level pixel power EVSS applied to the cathode electrode, the light emitting device EL may be turned on. When the light emitting device EL is turned on, a hole passing through the hole transport layer (HTL) and an electron passing through the electron transport layer (ETL) may move to the emission layer (EML) to generate an exciton, and thus, light may be emitted from the emission layer (EML).

The driving transistor DT may be a driving element. The driving transistor DT may generate a pixel current which is to be supplied to the light emitting device EL, based on a voltage difference between a gate node Ng and a source node Ns. The driving transistor DT may include a gate electrode connected to the gate node Ng, a first electrode connected to the high level pixel power EVDD, and a second electrode connected to the source node Ns.

The storage capacitor Cst may be connected between the gate node Ng and the source node Ns and may store a gate-source voltage of the driving transistor DT.

The first switch transistor ST1 may electrically connect the data line 15 to the gate node Ng, based on a gate signal SCAN(k), and may apply a data voltage VDATA, charged into the data line 15, to the gate node Ng. The first switch transistor ST1 may include a gate electrode connected to a gate line 17(k), a first electrode connected to the data line 15, and a second electrode connected to the gate node Ng.

The second switch transistor ST2 may electrically connect the readout line 16 to the source node Ns, based on the gate signal SCAN(k), and may apply a voltage of the source node Ns based on a pixel current to the readout line 16 or may apply a reference voltage Vref, charged into the readout line 16, to the source node Ns. The second switch transistor ST2 may include a gate electrode connected to the gate line 17(k), a first electrode connected to the source node Ns, and a second electrode connected to the readout line 16.

Such a pixel structure may be merely an example embodiment, and the inventive concept is not limited thereto. It should be noted that the inventive concept may be applied to various pixel structures for sensing an electrical characteristic (a threshold voltage or electron mobility) of the driving transistor DT.

The timing controller 11 may be connected to a host system 14 through a first interface circuit and may be connected to the data driver 12 through a second interface circuit. The first interface circuit and the second interface circuit may be the same or differ.

The timing controller 11 may receive a vertical synchronization signal Vsync, a data enable signal DE, and input video data DATA from the host system 14 through the first interface circuit.

As in FIG. 4, one frame may be defined by the vertical synchronization signal Vsync and the data enable signal DE, and moreover, a vertical active period ACT and a vertical blank period BLK of one frame may be defined. One frame may be defined as one period time of the vertical synchronization signal Vsync. The vertical active period ACT may be defined as a period where the data enable signal DE of one frame is shifted between a logic high level and a logic low level. The vertical blank period BLK may be defined as a period where the data enable signal DE of one frame is maintained at a logic low level.

A length of the vertical blank period BLK may vary based on the vertical synchronization signal Vsync and the data enable signal DE. The host system 14 may vary a length of the vertical blank period BLK to vary a frame frequency in driving, based on the complexity of the input video data DATA and the amount of inter-frame variation of the input video data DATA.

When the input video data DATA is complicated and the amount of inter-frame variation is large (for example, a gaming image where scene conversion is much), the host system 14 may decrease a length of the vertical blank period BLK where each frame is provided, thereby increasing a frame frequency. On the other hand, when the amount of inter-frame variation is not or small like a still image, the host system 14 may increase a length of the vertical blank period BLK where each frame is provided, thereby lowering a frame frequency. As described above, an operation of adjusting a length of the vertical blank period BLK to vary a frame frequency may be referred to as variable refresh rate (VRR) technology. The VRR technology may sufficiently secure a rendering time for graphics processing in the host system 14 to prevent a tearing phenomenon of an image, and thus, may provide a smoother image.

The electroluminescent display apparatus according to an example embodiment of the present disclosure may be a frequency variable display apparatus which operates in a VRR mode. In the VRR mode, a frame frequency may vary within a predetermined frequency variable range.

For example, as in FIG. 5, a frame frequency may be changed to A, B, and C Hz. A length of the vertical active period ACT may be determined with respect to a maximum frame frequency REF within the frequency variable range. A length of the vertical active period ACT may be fixed regardless of a variation of a frame frequency. On the other hand, a length of the vertical blank period BLK may vary based on a frame frequency. As a frame frequency decreases, a length of the vertical blank period BLK may increase. In FIG. 5, a length of the vertical blank period BLK may be BLK1 when a frame frequency is A Hz, a length of the vertical blank period BLK may be BLK2 when a frame frequency is B Hz, and a length of the vertical blank period BLK may be BLK3 when a frame frequency is C Hz. Here, when a relative magnitude of a frame frequency is A>B>C, BLK1<BLK2<BLK3.

The host system 14 may be mounted on a system board. The host system 14 may include an input unit which receives a user command/data, a main power unit which generates a main power, a VRR control circuit which varies a frame frequency, based on an input image, and an output unit which outputs a transfer signal. The host system 14 may be implemented with an application processor, a personal computer (PC), a set-top box, or a graphics process unit, but is not limited thereto.

The timing controller 11 may generate a timing control signal needed for display driving, real-time (RT) sensing driving, sensing line compensation (SLC) driving, and recovery driving and may provide the timing control signal to the data driver 12 and the gate driver 13 through the second interface circuit. The timing control signal may include a data timing control signal DDC for controlling an operation timing of the data driver 12 and a gate timing control signal GDC for controlling an operation timing of the gate driver 13.

As shown further in FIG. 4, display driving may be for image writing and may be performed during the vertical active period ACT. Image writing may be sequentially performed on all pixels PXL of the pixel array during the vertical active period ACT. That is, all pixels PXL may emit light during the vertical active period ACT, based on an image writing sequence in which image writing is sequentially performed by pixel line units.

RT sensing driving may be performed in the vertical blank period BLK where image writing is not performed. The RT sensing driving may be performed on one pixel line at a predetermined position and may be for sensing the electrical characteristic (i.e., the threshold voltage or electron mobility of a driving transistor) of target pixels included in a corresponding pixel line. A position of a pixel line on which the RT sensing driving is performed may be changed at every frame. To enhance sensing performance, the emission of light by target pixels may stop during an RT sensing period.

The RT sensing driving may be sequentially or non-sequentially performed one pixel line-by-one pixel line in a vertical blank period BLK of each frame. In a vertical blank period BLK of each frame, the other pixel lines except one pixel line on which RT sensing driving is performed may maintain an emission state (i.e., a display state) of a preceding vertical active period ACT.

SLC driving may be performed on target pixels of one pixel line (i.e., a sensing pixel line) on which RT sensing driving is completed. The SLC driving may be for compensating for luminance loss which occurs because the target pixels do not emit light during the RT sensing period. A luminance compensation data voltage for the SLC driving may be higher than a display data voltage which has been written for display driving.

Recovery (RECV) driving may be performed on target pixels of a sensing pixel line on which SLC driving is completed. Because luminance boosting is performed in target pixels through the SLC driving, the SLC driving may be performed for only a predetermined short time, and the recovery operation may be performed for the other time. A recovery period for recovery driving may be continued until before image writing of a subsequent frame.

The recovery (RECV) driving may lower the luminance of target pixels from a booting level to a display driving level. A luminance recovery data voltage for recovery driving may be higher than or equal to the display data voltage. A sensing pixel line may be recognized as a bright line due to luminance boosting in long-time SLC driving, recovery driving associated with short SLC driving may effectively prevent a side effect.

The timing controller 11 may receive sensing data based on RT sensing driving from the data driver 12 through the second interface circuit. An electrical characteristic of the driving transistor DT included in each of sensed pixels PXL may be reflected in the sensing data. The timing controller 11 may calculate a pixel compensation value for compensating for an electrical characteristic deviation between the pixels PXL, based on the sensing data, and may correct input video data DATA, based on the pixel compensation value. The timing controller 11 may supply image data DATA, obtained through correction based on the pixel compensation value, to the data driver 12 through the second interface circuit.

The gate driver 13 may be provided in a non-display area NA of the display panel 10, based on a gate driver in panel (GIP) type. The gate driver 13 may generate a gate signal SCAN which swings between an on voltage and an off voltage, based on the gate timing control signal GDC. The gate driver 13 may line-sequentially supply the gate signal SCAN to gate line 17(1) to 17(4) in the vertical active period ACT of each frame. The gate driver 13 may supply the gate signal SCAN to the gate line 17 connected to the pixels PXL of the sensing pixel line in the vertical blank period BLK of each frame.

The data driver 12 may be implemented as a data integrated circuit (IC). The data driver 12 may include a data voltage supply unit (DAC) 121 which generates a data voltage VDATA, based on the data timing control signal DDC, and a sensing circuit (SU) 122. The data voltage VDATA may be divided into a display data voltage, a sensing data voltage, a luminance compensation data voltage, and a luminance recovery data voltage.

The data voltage supply unit (DAC) 121 may be connected to the pixel array through one of the data lines 15. The data voltage supply unit (DAC) 121 may generate display data voltages having a voltage level varying based on a gray level of the image data DATA for display driving in the vertical active period ACT of each frame and may supply the display data voltage to the data lines 15. The display data voltages may be supplied to gate nodes Ng of all pixels PXL in synchronization with the gate signal SCAN. The data voltage supply unit (DAC) 121 may generate sensing data voltages for RT sensing driving in the vertical blank period BLK of each frame to supply the sensing data voltages to the data lines 15, may subsequently generate luminance recovery data voltages for SLC driving to supply the luminance recovery data voltages to the data lines 15, and may then generate luminance recovery data voltages for recovery driving to supply the luminance recovery data voltages to the data lines 15. The sensing data voltage, the luminance compensation data voltage, and the luminance recovery data voltage may be supplied to gate nodes Ng of target pixels PXL in synchronization with different pulses of the gate signal SCAN.

The sensing circuit (SU) 122 may be connected to target pixels PXL of a sensing pixel line through the readout lines 18. The sensing circuit (SU) 122 may sense, through the readout lines 18, pixel currents flowing in the target pixels PXL on the basis of the sensing data voltage or source node voltages of the target pixels PXL based on the pixel currents. The pixel current or the source node voltage may vary based on the degree of degradation of the target pixel PXL.

The sensing circuit (SU) 122 may be implemented as a voltage sensing type which samples the source node voltage, or may be implemented as a current sensing type which samples the pixel current.

A voltage sensing type sensing circuit (SU) 122, as in FIG. 3, may include a sampling circuit SAM and an analog-to-digital converter ADC. The sampling circuit SAM may directly sample a source node voltage of a sensing target pixel PXL stored in a parasitic capacitor of the readout line 16. The analog-to-digital converter ADC may convert an analog voltage, obtained through sampling by the sampling circuit SAM, into a digital sensing result value and may transfer the digital sensing result value to the timing controller 11.

A current sensing type sensing circuit (SU) 122 may include a current integrator, a sampling circuit, and an analog-to-digital converter. The current integrator may perform an integral on the pixel current flowing in the sensing target pixel PXL to output a sensing voltage. The sampling circuit may sample the sensing voltage which is output from the current integrator. The analog-to-digital converter may convert an analog voltage, obtained through sampling by the sampling circuit, into a digital sensing result value and may transfer the digital sensing result value to the timing controller 11.

In each of the display driving, the RT sensing driving, the SLC driving, and the recovery (RECV) driving, the sensing circuit (SU) 122 may turn on a first switch SW1 to allow the reference voltage Vref to the readout line 16, based on a timing at which the data voltage VDATA is supplied to the data line 15. The reference voltage Vref charged into the readout line 16 may be supplied to the source node Ns of the pixel PXL in synchronization with the gate signal SCAN.

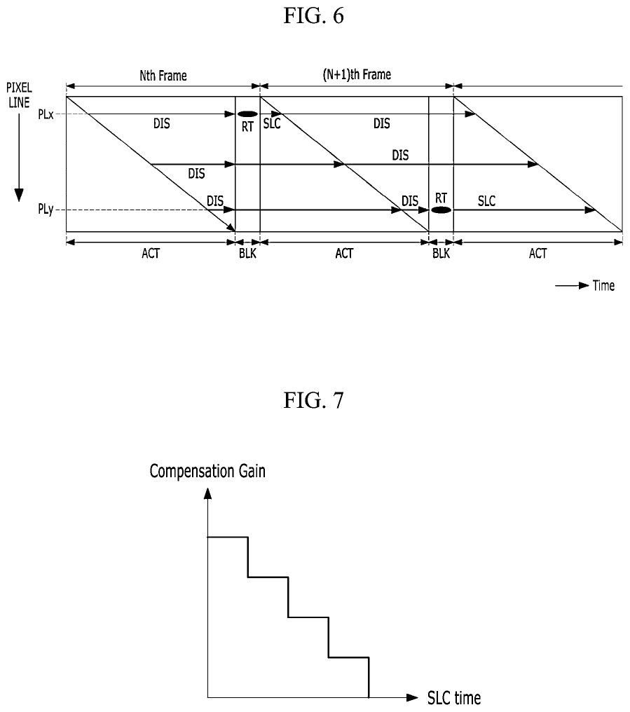

FIG. 6 is a diagram illustrating a case where RT sensing driving, SLC driving, and recovery driving are performed on one sensing pixel line at a different position for each frame. FIG. 7 is a diagram illustrating an example where a compensation gain is differentially set based on a length of an SLC period.

As illustrated in FIG. 6, display driving DIS may be line-sequentially performed on all pixel lines in an image writing period included in a vertical active period ACT of an N^{th} frame. RT sensing driving may be performed on a sensing pixel line PLx in a sensing period included in a vertical blank period BLK of the N^{th} frame. Also, SLC driving on the sensing pixel line PLx may be performed in a sensing line compensation period succeeding the sensing period, and recovery (RECV) driving on the sensing pixel line PLx may be performed in a recovery period succeeding the sensing line compensation period.

Display driving DIS may be line-sequentially performed on all pixel lines in an image writing period included in a vertical active period ACT of an N^{th}+1 frame. RT sensing driving may be performed on a sensing pixel line PLy in a sensing period included in a vertical blank period BLK of the N^{th}+1 frame. Also, SLC driving on the sensing pixel line PLy may be performed in an SLC period succeeding the sensing period, and recovery (RECV) driving on the sensing pixel line PLy may be performed in a recovery period succeeding the SLC period.

A length of an SLC period may be shortest in a panel upper end which is highest in display driving DIS sequence, and a length of the SLC period may be longest in a panel lower end which is lowest in display driving DIS sequence. For uniform compensation at all panel positions, as in FIG. 7, a compensation gain may be differentially set based on a length of the SLC period. That is, the compensation gain may be set to be largest based on the panel upper end where a length of the SLC period is shortest and may be set to be smallest based on the panel lower end where a length of the SLC period is longest.

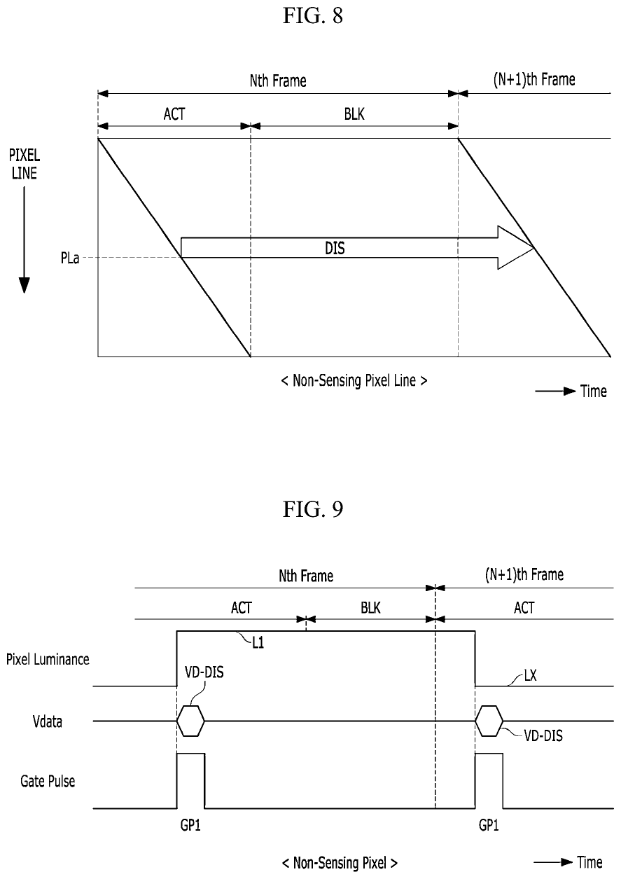

FIGS. 8 and 9 are diagrams illustrating display driving of a non-sensing pixel line.

As shown in FIGS. 8 and 9, in an image writing period of each of an N^{th} frame and an N^{th}+1 frame, a non-sensing pixel included in a non-sensing pixel line PLa may be supplied with a display data voltage VD-DIS synchronized with a first gate pulse GP1 and may perform display driving DIS.

The luminance of a non-sensing pixel may be changed based on a level of the display data voltage VD-DIS. The luminance of a non-sensing pixel in the N^{th} frame may be L1, and the luminance of a non-sensing pixel in the N^{th}+1 frame may be Lx. The luminance of a non-sensing pixel may be updated in a vertical active period ACT of each frame, and updated pixel luminance may be intactly maintained in a vertical blank period BLK also.

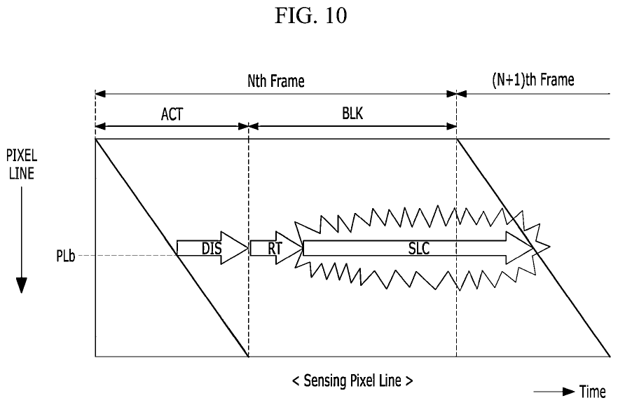

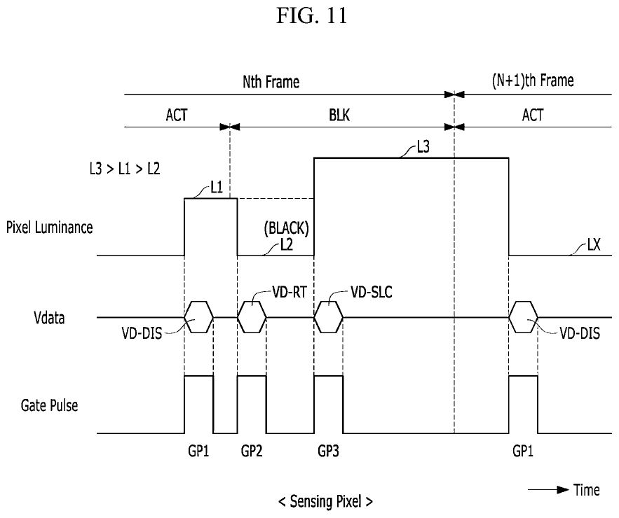

FIGS. 10 and 11 are diagrams illustrating a case where long-time SLC driving succeeding RT sensing driving is performed on a sensing pixel line, in a comparative example.

As illustrated in FIGS. 10 and 11, in an image writing period of a vertical active period ACT of an N^{th} frame, a target pixel (i.e., a sensing pixel) included in a sensing pixel line PLb may be supplied with a display data voltage VD-DIS synchronized with a first gate pulse GP1 and may perform display driving DIS.

Subsequently, in a sensing period of a vertical blank period BLK of the N^{th} frame, a target pixel may be supplied with a sensing data voltage VD-RT synchronized with a second gate pulse GP2 and may perform RT sensing driving. Also, in an SLC period succeeding the sensing period, a target pixel may be supplied with a luminance compensation data voltage VD-SLC synchronized with a third gate pulse GP3 and may perform SLC driving. The SLC period may be continued until before image writing of an N^{th}+1 frame.

The luminance of a target pixel may be L1 in the image writing period, may be L2 corresponding to a black gray level in the sensing period, and may be L3 which is greater than L1 in the SLC period. The luminance of the target pixel may be boosted to L3 which is greater than L1, based on SLC driving, and thus, luminance loss caused by non-emission in the sensing period may be compensated for.

According to the comparative example, when a frame frequency is low in a VRR mode, the SLC period where luminance is boosted may increase, and thus, a sensing pixel line PLb may be recognized as a bright line.

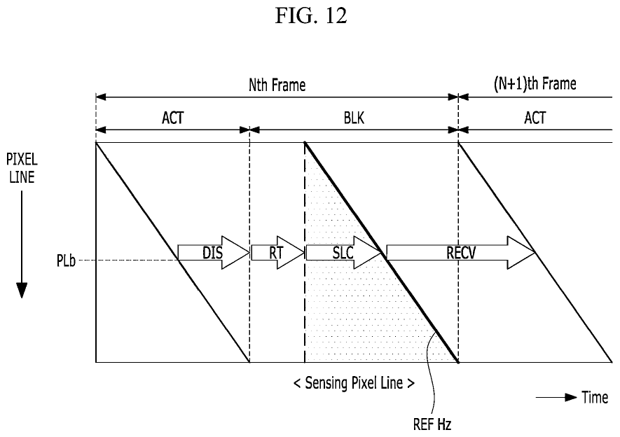

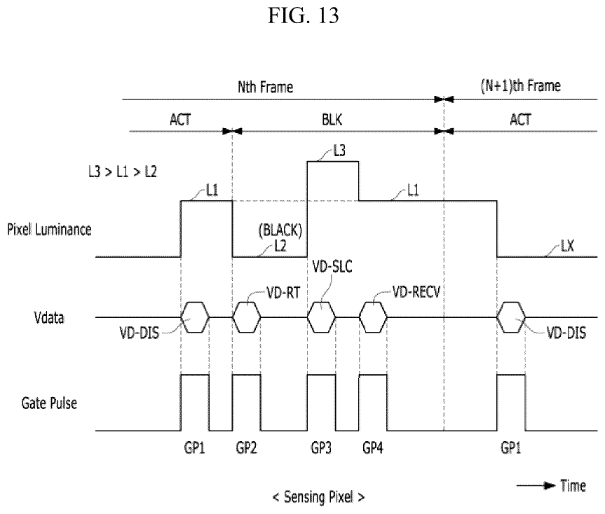

FIGS. 12 and 13 are diagrams illustrating RT sensing driving, SLC driving, and recovery (RECV) driving of a sensing pixel line in an example embodiment.

As shown in FIGS. 12 and 13, in an image writing period of a vertical active period ACT of an N^{th} frame, a target pixel (i.e., a sensing pixel) included in a sensing pixel line PLb may be supplied with a display data voltage VD-DIS synchronized with a first gate pulse GP1 and may perform display driving DIS.

Subsequently, in a sensing period of a vertical blank period BLK of the N^{th} frame, a target pixel may be supplied with a sensing data voltage VD-RT synchronized with a second gate pulse GP2 and may perform RT sensing driving. Also, in an SLC period succeeding the sensing period, a target pixel may be supplied with a luminance compensation data voltage VD-SLC synchronized with a third gate pulse GP3 and may perform SLC driving. Also, in a recovery (RECV) period succeeding the SLC period, a target pixel may be supplied with a luminance recovery data voltage VD-RECV synchronized with a fourth gate pulse GP4 and may perform recovery (RECV) driving.

The image writing period, the sensing period, the SLC period, and the recovery (RECV) period may be sequentially continued.

Because the luminance compensation data voltage VD-SLC is for luminance boosting, the luminance compensation data voltage VD-SLC may have a voltage level which is higher than that of the display data voltage VD-DIS. On the other hand, the luminance recovery data voltage VD-RECV may be for preventing a sensing pixel line PLb from being recognized as a bright line, and thus, may have the same voltage level as that of the display data voltage VD-DIS.

The luminance of a target pixel may be L1 in the image writing period, may be L2 corresponding to a black gray level in the sensing period, and may be L3 which is greater than L1 in the SLC period. The luminance of the target pixel may be boosted to L3 which is greater than L1, based on SLC driving, and thus, luminance loss caused by non-emission in the sensing period may be compensated for.

In the comparative example described above, there may be a problem where a length of an SLC period corresponding to the sensing pixel line PLb at the same position increases based on a level of a frame frequency. In an example embodiment of the present disclosure, a length of an SLC period corresponding to the sensing pixel line PLb at the same position may be fixed regardless of a change in frame frequency. In other words, in an example embodiment of the present disclosure, a length of the SLC period corresponding to the sensing pixel line PLb at the same position may be fixed with respect to a maximum frame frequency (REF Hz) within a predetermined frequency variable range. However, SLC periods may have different fixed lengths, based on a position of the sensing pixel line PLb.

In an example embodiment of the present disclosure, SLC driving may be performed for only a predetermined short time, and recovery (RECV) driving may be performed for the other time. The recovery (RECV) period may be continued until before image writing of an N^{th}+1 frame. Recovery (RECV) driving may lower the luminance of a target pixel from a boosting level L3 to a display driving level L1. A length of an SLC period corresponding to the sensing pixel line PLb at the same position may be fixed regardless of a change in frame frequency. On the other hand, a length of the recovery (RECV) period corresponding to the sensing pixel line PLb at the same position may be changed based on a change in frame frequency. As a frame frequency decreases, a length of the recovery (RECV) period may increase, and as a frame frequency increases, a length of the recovery (RECV) period may decrease.

Furthermore, in an example embodiment of the present disclosure, it has been described that the luminance recovery data voltage VD-RECV has the same voltage level as that of the display data voltage VD-DIS, but the luminance recovery data voltage VD-RECV may be applied at a level which is higher than that of the display data voltage VD-DIS, based on a gray level of the display data voltage VD-DIS. For example, when a gray level of the display data voltage VD-DIS is higher than or equal to a middle gray level, the luminance recovery data voltage VD-RECV may have the same voltage level as that of the display data voltage VD-DIS. On the other hand, when a gray level of the display data voltage VD-DIS is a low gray level, the luminance recovery data voltage VD-RECV may be additionally adjusted to have a voltage level between the display data voltage VD-DIS and the luminance compensation data voltage VD-SLC. This may be because a luminance difference caused by a change in frame frequency occurs in expressing a low gray level, and due to this, a sensing pixel line is seen to be relatively dark. However, such a problem may not occur in a middle gray level or more.

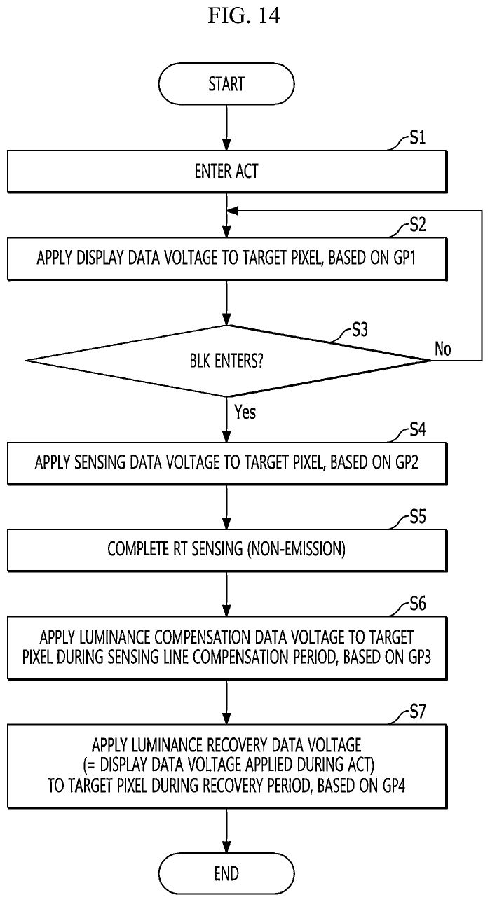

FIG. 14 is a diagram illustrating a driving method of an electroluminescent display apparatus according to an example embodiment of the present disclosure.

As illustrated in FIG. 14, the driving method according to an example embodiment of the present disclosure may apply a display data voltage VD-DIS synchronized with a first gate pulse GP1 to a target pixel (i.e., a sensing pixel) included in a sensing pixel line PLb to perform display driving of the target pixel in an image writing period of a vertical active period ACT (S1 and S2). The target pixel may emit light, based on the display driving.

Subsequently, the driving method according to an example embodiment of the present disclosure may apply a sensing data voltage VD-RT synchronized with a second gate pulse GP2 to the target pixel to perform RT sensing driving of the target pixel in a sensing period of a vertical blank period BLK (S3 and S4). The target pixel may stop the emission of light in the RT sensing driving. To stop the emission of light by the target pixel, the driving method according to an example embodiment of the present disclosure may increase a low level pixel power EVSS (see FIG. 3), applied to a cathode electrode of a light emitting device, to a reference voltage Vref (see FIG. 3) during a sensing period.

When RT sensing in a non-emission state is completed (S5), the driving method according to an example embodiment of the present disclosure may apply a luminance compensation data voltage VD-SLC synchronized with a third gate pulse GP3 to the target pixel to perform SLC sensing driving of the target pixel in an SLC period succeeding the sensing period (S6). A length of the SLC period may be fixed to a short time, regardless of a change in frame frequency. Based on SLC driving, luminance loss caused by non-emission in the sensing period may be compensated for.

Subsequently, the driving method according to an example embodiment of the present disclosure may apply a luminance recovery data voltage VD-RECV synchronized with a fourth gate pulse GP4 to the target pixel to perform recovery (RECV) driving of the target pixel in a recovery (RECV) period succeeding the SLC period (S7). Because the luminance recovery data voltage VD-RECV has the same level as that of the display data voltage VD-DIS, the luminance of the target pixel may be lowered from a boosting level to a display driving level.

According to an example embodiment of the present disclosure, a luminance deviation occurring between a sensing pixel and a non-sensing pixel may be effectively reduced.

The effects according to the present disclosure are not limited to the above examples, and other various effects may be included in the specification.

While the present disclosure has been particularly shown and described with reference to example embodiments thereof, it will be understood by those of ordinary skill in the art that various changes in form and details may be made therein without departing from the spirit and scope of the present disclosure. Therefore, the above example embodiments of the present disclosure are provided for illustrative purposes and are not intended to limit the scope or technical concept of the present disclosure. The protective scope of the present disclosure should be construed based on the following claims and their equivalents, and it is intended that the present disclosure cover all modifications and variations of this disclosure that come within the scope of the claims and their equivalents.

What is claimed is:

1. An electroluminescent display apparatus, comprising:
a display panel including a target pixel for sensing;
a data driver configured to supply a display data voltage to the target pixel in an image writing period of one frame, supply a sensing data voltage to the target pixel in a sensing period, supply a luminance compensation data voltage to the target pixel in a sensing line compensation period, and supply a luminance recovery data voltage to the target pixel in a recovery period; and
a sensing circuit configured to sense an electrical characteristic of the target pixel based on the sensing data voltage in the sensing period,
wherein the image writing period, the sensing period, the sensing line compensation period, and the recovery period are sequentially arranged,
wherein the luminance compensation data voltage has a voltage level higher than the display data voltage, and
wherein the luminance recovery data voltage is within a recovery voltage range including the display data voltage and the luminance compensation data voltage.

2. The electroluminescent display apparatus of claim 1, wherein the luminance recovery data voltage has a same voltage level as the display data voltage.

3. The electroluminescent display apparatus of claim 1, wherein a length of the sensing line compensation period is fixed regardless of a change in frame frequency.

4. The electroluminescent display apparatus of claim 1, wherein a length of the sensing line compensation period is fixed based on a maximum frame frequency within a frequency variable range.

5. The electroluminescent display apparatus of claim 1, wherein a length of the recovery period is changed based on a change in frame frequency.

6. The electroluminescent display apparatus of claim 5, wherein the length of the recovery period increases as the frame frequency is lowered.

7. The electroluminescent display apparatus of claim 1, wherein a compensation gain for determining a level of the luminance compensation data voltage is differentially set based on a position of a pixel line including the target pixel.

8. The electroluminescent display apparatus of claim 1, further comprising:
a gate driver configured to supply the target pixel with a first gate pulse synchronized with the display data voltage in the image writing period, supply the target pixel with a second gate pulse synchronized with the sensing data voltage in the sensing period, supply the target pixel with a third gate pulse synchronized with the luminance compensation data voltage in the sensing line compensation period, and supply the target pixel with a fourth gate pulse synchronized with the luminance recovery data voltage in the recovery period.

9. A driving method of an electroluminescent display apparatus including a display panel including a target pixel for sensing, the driving method comprising:
supplying a display data voltage to the target pixel in an image writing period of one frame;
supplying a sensing data voltage to the target pixel in a sensing period;
supplying a luminance compensation data voltage to the target pixel in a sensing line compensation period;
supplying a luminance recovery data voltage to the target pixel in a recovery period; and
sensing an electrical characteristic of the target pixel based on the sensing data voltage in the sensing period,
wherein the image writing period, the sensing period, the sensing line compensation period, and the recovery period are sequentially arranged,
wherein the luminance compensation data voltage has a voltage level higher than the display data voltage, and
wherein the luminance recovery data voltage is within a recovery voltage range including the display data voltage and the luminance compensation data voltage.

10. The driving method of claim 9, wherein the luminance recovery data voltage has a same voltage level as the display data voltage.

11. The driving method of claim 9, wherein a length of the sensing line compensation period is fixed regardless of a change in frame frequency.

12. The driving method of claim 9, wherein a length of the sensing line compensation period is fixed based on a maximum frame frequency within a frequency variable range.

13. The driving method of claim 9, wherein a length of the recovery period is changed based on a change in frame frequency.

14. The driving method of claim 13, wherein the length of the recovery period increases as the frame frequency is lowered.

15. The driving method of claim 9, wherein a compensation gain for determining a level of the luminance compensation data voltage is differentially set based on a position of a pixel line including the target pixel.

16. The driving method of claim 9, further comprising:
supplying the target pixel with a first gate pulse synchronized with the display data voltage in the image writing period;
supplying the target pixel with a second gate pulse synchronized with the sensing data voltage in the sensing period;
supplying the target pixel with a third gate pulse synchronized with the luminance compensation data voltage in the sensing line compensation period; and
supplying the target pixel with a fourth gate pulse synchronized with the luminance recovery data voltage in the recovery period.
